(19) United States
(12) Patent Application Publication
(10) Pub. No.: US 2017/0090427 A1
(43) Pub. Date: Mar. 30, 2017

(54) UTILITY PROVISIONING WITH IOT ANALYTICS

(71) Applicant: Intel Corporation, Santa Clara, CA (US)

(72) Inventors: Robert L. Vaughn, Portland, OR (US); Rong Gao, Hillsboro, OR (US)

(73) Assignee: Intel Corporation, Santa Clara, CA (US)

(21) Appl. No.: 14/866,492

(22) Filed: Sep. 25, 2015

(51) Int. Cl. G05B 5/01

(52) U.S. Cl. CPC G05B 5/01

(57) ABSTRACT

Briefly, in accordance with one or more embodiments, an analytic system controls operation of a machine. The analytic system includes a sensor device to monitor power utilized by the machine, and to collect load data for the machine during startup. The analytic system further includes an analytic engine to determine a start time for the machine based at least in part on the load data for the machine received from the sensor device, and to communicate the determined start time to the machine. Start times for multiple machines may be selected wherein a maximum allowable current is not exceeded during the startup of the machines based at least in part on startup signatures for the machines generated from the load data.

### BACKGROUND

Many electrically powered systems require much larger amounts of current at start up than during regular operation. For example, in factories where there are many machines the electrical service to the factory has to be designed to handle these startup spikes in electrical consumption. Additionally, many of these electricity demand spikes can hit electric utility providers at the same time requiring a much larger sized grid then what otherwise would be required during normal load.

Existing power management systems can provide stepped startup for systems that are interconnected in some manner. Many motor driven appliances such as refrigerators and air conditioners require much larger amounts of current at initial startup than is required for normal running operation. This higher initial current is referred to as Locked Rotor Amps (LRA) sometimes called Locked Rotor Current. LRA is typically three to eight times the continuous operating current which is referred to as Full Load Amps (FLA) or Running Load Amps (RLA). LRA typically lasts from slightly under one second to ten seconds, for example for large electric motors in factories. A data center may utilize multiple Computer Room Air Conditioning (CRAC) systems. The sizing of a data center power system may be based on the sum of operating load balanced against the expected LRA load. Other example devices having higher startup current are two and one-half ton air conditioners designed to be run off of a 30 ampere service. Typical factory designs, however, do not take into consideration the collective electrical demand impact of initial startup of electrically driven systems. As a result, the electrical systems supporting the facility are designed either around the sum of maximum load being the startup load, or of the sum of the running load. In either arrangement there are inefficiencies with the service infrastructure being designed to be potentially larger than needed or smaller than needed. Additionally, these systems do not have any way to adjust demand based on the time varying costs of the electricity from the utility provider.

Utility providers such as natural gas and electricity, described as utility services, typically charge customers varying amounts based on the time of day. The amount charged at a given time of day is primarily as a mechanism of supply and demand. In this mechanism utility providers want to encourage their customers to use utility services when demand is low by lowering prices during those time periods. One way to take advantage of such pricing is simply to startup machines only during lower cost time periods, but this is not always practical. As a result, there exists the potential for a greater level of efficiency.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a block diagram of a process flow among devices involved utility provisioning with Internet of Things (IOT) analytics in accordance with one or more embodiments;

FIG. 2 is a diagram of the startup current of a two stage startup machine in accordance with one or more embodiments;

FIG. 3 is a block diagram of an architecture to implement utility provisioning with IOT analytics in accordance with one or more embodiments;

FIGS. 4A and 4B show a flow diagram of a process to calibrate the operation of a machine using IOT analytics in accordance with one or more embodiments;

FIG. 5 is a diagram of an Internet of Things (IOT) device in accordance with one or more embodiments; and

FIG. 6 is a block diagram of an information handling system capable of implementing utility provisioning with IOT analytics in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

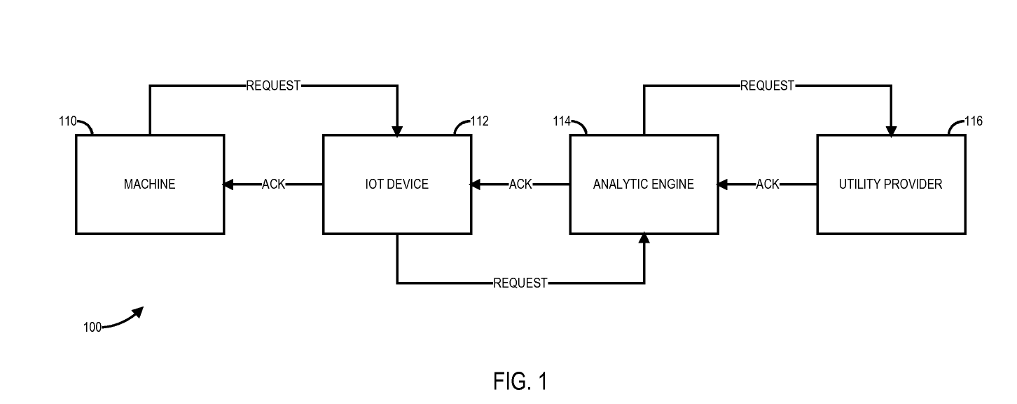

Referring now to FIG. 1, a block diagram of a process flow among devices involved in utility provisioning with Internet of Things (IOT) analytics in accordance with one or more embodiments will be discussed. As shown in FIG. 1, analytic system 100 may include a machine 110 to be operated and monitored, for example at a factory or at the home of a consumer. Machine 110 may be coupled with an Internet of Things (IOT) device 112 that is capable of monitoring and/or controlling the operation of machine 110, for example when machine 110 is initially turned on or started up. In one or more embodiments, IOT device 112 may be embedded within the hardware of machine 110, either at manufacture of machine 110 or as an add-on device that is added to machine 110 at some point. Alternatively, IOT device 112 may be a device that is coupled to machine 110 as an external device that may be self-contained and that is able to monitor and/or control machine 110, for example by coupling to the mains power input of machine 110. IOT 112 may collect data regarding the operation of machine 110 and send the data to an analytic engine 114. Analytic engine 114 may comprise, for example, software running on a general purpose computing platform or server, or may comprise specialized hardware designed to collect analytic data from one or more IOT devices 112 regarding the operation of one or more machines 112. In some embodiments, analytic engine 114 may be located at the same factory or home at which machine 110 is located, and in other embodiment analytic engine 114 may be located on a network or in a cloud server that is coupled with IOT device 112, for example via a remote network or cloud service to which the factory or home user subscribes. In other embodiments, analytic engine 114 may be located at a facility of a utility provider 116 that provides power to the factory or home to power machine 110. In one or more embodiments, analytic system 100 may comprise multiple machines 110 and/or multiple IOT devices 112 wherein the multiple machines 110 may comprise, for example, air conditioners, factory presses, banks of servers of a data center, and so on. In some embodiments, analytic system 110 may scale to a large number factories, data centers, or homes. It should be noted that these are merely example arrangements and/or deployments of analytic system 100, and the scope of the claimed subject matter is not limited in these respects.

In one or more embodiments, IOT device 112 monitors requests from machine 110 and passes those requests up to analytic engine 114. Analytic engine 114 may observe requests that are received from one or more machines 110 of analytic system 100 that are submitting requests, and based at least in part on knowledge of the requests analytic engine 114 may send an acknowledgment (ACK) back to IOT device 112 and/or machine 110. Such an acknowledgment may include a directive to either start machine 110 in response to the request, or to hold the startup of machine 110 for an indicated period of time. In some embodiments comprising larger scale implementations of analytic system 100, the requests from multiple machines 110 may be aggregated and controlled as a group, or passed on to utility provider 116. In such cases, utility provider 116 may analyze the request from the multiple machines that are submitting requests. Based at least in part on knowledge of the requests, utility provider 116 may reply with an appropriate acknowledgment back to analytic engine 114, or some cases the acknowledgement by utility provider 116 may be sent back downstream to the customer or user to IOT device 112 and/or to machine 110 via IOT device 112 indicating an appropriate startup time for machine 110, for example either immediately after receiving the acknowledgment, after a predetermined delay, or at an appropriate scheduled time. Such a bilateral feedback arrangement of requests and acknowledgements as shown in FIG. 1 may optimize the efficiency of analytic system 100 by leveraging an Internet of Things (IOT) infrastructure to reduce the build out involved for analytic system 100 as well as to reduce the overall electric load consumed by the machines 110 of analytic system. For purposes of discussion, analytic system 100 will be discussed as applied to the electrical service provisioning of larger scale industrial applications, although analytic system 100 also could be applied to smaller scale industrial applications and/or home or consumer applications, and the scope of the claimed subject matter is not limited in these respects.

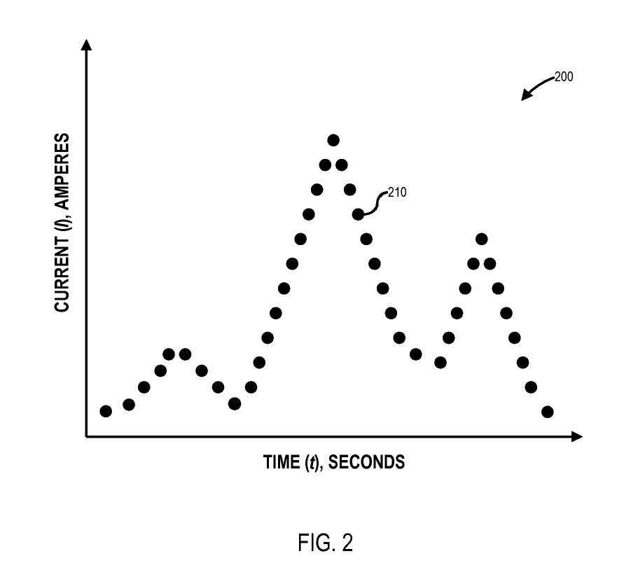

In one or more embodiments analytic system 100 may collect requests for electric power including spikes or other usage characteristics that can be balanced against the needs of other machines to optimize the larger power distribution system. In one example embodiment, for the startup of machine 110, machine 110 makes a request to start. The request may include the start load which may be the number of amperes needed to startup, running load, duration and start time flexibility in time. The request is submitted to analytic engine 114, and analytic engine 114 determines when the request can be serviced through analysis of cost, historic load data, and/or real-time load data requests from the service area. Analytic engine 114 then sends information to machine 110 indicating to machine 110 when to start. In another example wherein utility provider 116 has excess power, utility provider 116, or some smaller provider of power, identifies that it has extra power. Utility provider 116 advertises to customers identified via analytics that a defined amount of power is available at a predetermined time. In such an arrangement, analytic system, 100 leverages predictive analytics to determine which customer would most likely accept the offer. In some embodiments, the number of offers may be controlled or limited so that analytic system 100 does not receive too many acceptances of the offer for power. In response to the offer for power, the identified customer may accept the offer for available power and use the extra power to operate one or more machines 110, for example to utilize the extra power to startup one or more machines 110 according to the startup load curves of the machines. An example startup load curve for machine 114 is shown in and described with respect to FIG. 2, below.

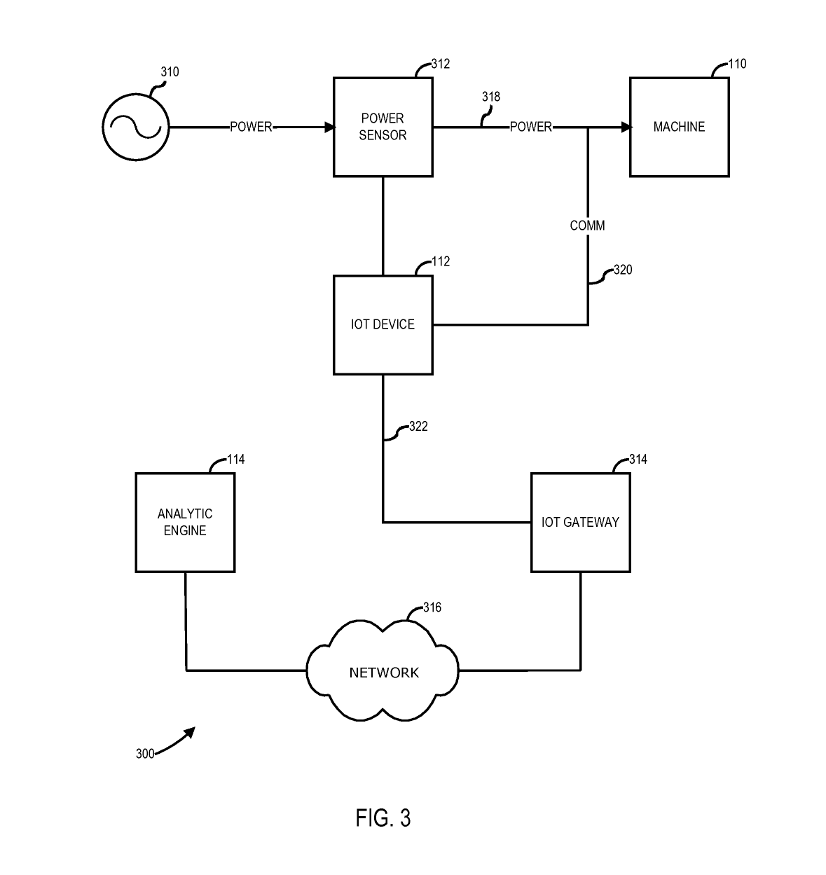

Referring now to FIG. 2, a diagram of the startup current of a two stage startup machine in accordance with one or more embodiments will be discussed. As shown in FIG. 2, graph 200 shows a plot of an example startup load curve 210 of machine 110 in current versus time. The startup load curve 210 may be monitored and obtained by IOT device 112 and provided to analytic engine 114 for management of the startup and/or operation of one or more machines 110 by analytic system 100. In one or more embodiments, IOT device 112 is able to be configured and deployed in a large scale manner for multiple machines 110. In some embodiments IOT device 112 may be associated with one particular machine 110, and in other embodiments IOT device 110 may be configured to monitor multiple machines 110. IOT device 112 furthermore may be able to communicate upstream with one or more gateways, for example as shown in FIG. 3, below, to provide the data collected on one or more machines 110 to one or more analytic engines 114 via the gateways. IOT device 112 may provide several functions including but not limited to the ability to collect information from the machine 110 to which it is attached or otherwise coupled. Such information may include a start request, a delay in startup that machine 110 can tolerate, and/or the load requirement of machine 110 including for example, startup load curve 210. In one or more embodiments, IOT device 112 may be configured to work with an existing or legacy machine 110 that may not include the functions of IOT device 112 as discussed herein to allow for a more sophisticated analysis and operation of machine 110.

For example, in one or more embodiments, analytic system 100 may be deployed in a utility provisioning system. IOT device 112 may be plugged into a power sensor coupled to machine 110 in line with the power line of machine. Alternatively, IOT device 112 itself may include a power sensor in which case IOT device 112 may be disposed directly in line with the power line of machine 110. Machine 110 may not be able to provide its startup load curve 210 to IOT device 112. Furthermore, even if a current or load rating of machine 110 is printed on the case of machine 110 or is otherwise published by the manufacturer of machine 110, such current or load ratings typically are static values and do not provide information regarding the startup load current over time as shown in graph 200. In some embodiments, IOT device 112 may run machine 110 through one or more cycles to collect information on machine 110. In other embodiments, IOT device 112 may continuously collect load usage information for machine 110 to allow for continuous refinement of load requirement of machine 110 and/or for the collective load requirements of multiple machines 110 to obtain a signature for each of the machines 110, for example a signature startup load curve plot 210 for one or more of the machines 110. The load data for the one or more machines 110 may be utilized by analytic engine 114 to provide start times to the machines 110 in an efficient manner while providing flexibility to allow for the operators of the facility to adjust the operating cycle, manufacturing pace, and so on of one or more machines 110 collectively. An example of an architecture to allow such control of one or more machines 110 is shown in and described with respect to FIG. 3, below.

Referring now to FIG. 3, a block diagram of an architecture to implement utility provisioning with IOT analytics in accordance with one or more embodiments will be discussed. As shown in FIG. 3, architecture 300 may include at least some of the elements of analytic system 100 of FIG. 1. Architecture 300 includes a power source 310 to provide alternating-current (ac) power to operate one or more machines 110. Alternatively, power source 310 may provide direct-current (dc) power, and the scope of the claimed subject matter is not limited in this respect. A power sensor 312 may be disposed between power source 310 and machine 110 in line with the power line 318 of machine 110, for example to monitor the power delivered to machine 310. Power sensor 312 may comprise an ammeter, a voltmeter, or a combination thereof, and may be capable of monitoring the electrical power provided to and consumed by machine 110 and the fluctuations of the power over time. IOT device 112 may couple to power sensor 312 to obtain the power data from power sensor 312. In addition, IOT device 112 may have a communication line 320 to couple with machine 110, for example if machine 110 provides a data port to which IOT device 112 may connect to obtain data directly from machine 110. IOT device 112 may communicate with an IOT gateway 314 via link 322 which may comprise a wired link or a wireless link. IOT gateway 314 in turn couples with analytic engine 114 via network 316 which may comprise the Internet or a cloud network or service to forward the data collected by IOT device 112 with power sensor 312 to analytic engine 114. In some embodiments, machine 110 may forward a request to power on via communication link 320 to IOT device 112 which in turn forwards the request to analytic engine 114 via IOT gateway 314 and network 316, for example as discussed with respect to FIG. 1.

In one or more embodiments, architecture 300 may be arranged to provide analytics on the edge, analytics local but offloaded to a server, or analytics at utility provider 116 on a larger, more centralized scale such as a utility provider 116 for a whole city. Analytic engine 114 may connect to a communication link 320 to provide feedback to machine through IOT device 112 via network 316 and IOT gateway 314 indicating to machine 110 when to start or hold off a start for a period of time. In some embodiments, machine 110 may indicate that a start is requested at a specific time. Machine 110 may indicate whether the requested start time is mandatory and that it needs to startup immediately, or whether the requested startup time is discretionary in which case the startup time of machine 110 may be adjusted. Machine 110 may indicate a maximum delay time in which it is requested to startup, a start time and stop time window in which it is requesting to operate, and its load requirement which may be provided by machine 110 or may be obtained from stored historical data. IOT device 112 may monitor the base of a current spike at initiation of a load at startup wherein the base of the current spike may be identified to represent a trigger point that a request is forming in or otherwise being provided by machine 110. A utility provisioning system may comprise, for example, analytic engine 114 or a server on which analytic engine 114 is running. The utility provisioning system may be located at the factory or at utility provider 116 and may advertise that a window for startup for machine 110 is available. The utility provisioning system may indicate to machine 110 a start time and stop time window in which machine 110 may startup and operate, and further may indicate the load allowed by machine 110.

In some embodiments, architecture 300 may be applied to the context of managing large factory systems, for example factory systems comprising one or more machines 110 having electric motor driven systems. In addition, architecture 300 may be implemented across an entire utility service area including multiple suppliers and consumers. Application of architecture 300 may result in a factory being able to increase an effective electric service load maximum without adding any actual service. Such an arrangement may result in a significant capital saving in electric service equipment may allow for the avoidance of having to relocating a factory to a new site due to utility infrastructure limitations. It should be noted, however, that these are merely example implementation of architecture 300, and the scope of the claimed subject matter is not limited in these respects.

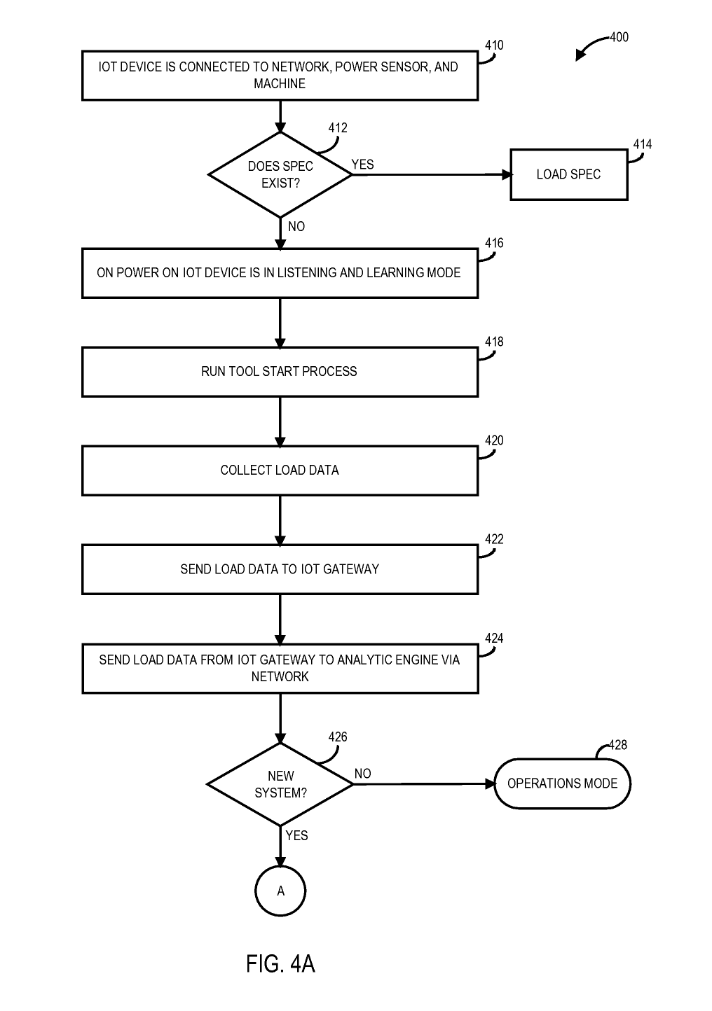

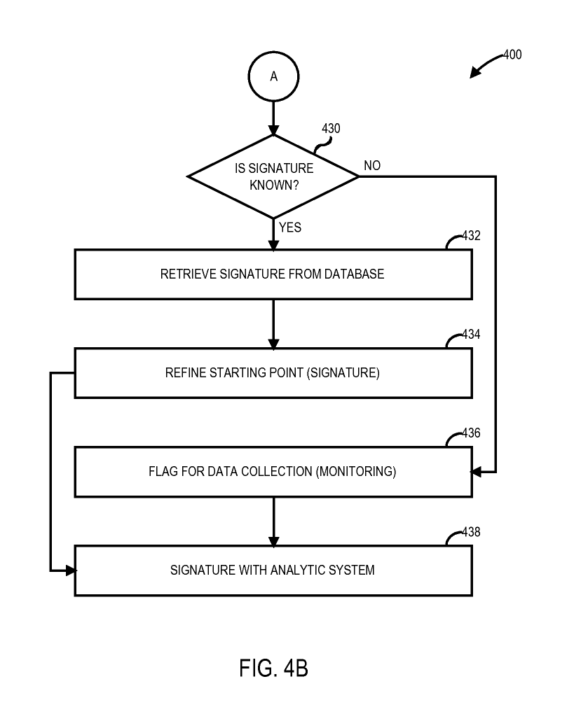

Referring now to FIGS. 4A and 4B, a flow diagram of a process to calibrate the operation of a machine using IOT analytics in accordance with one or more embodiments will be discussed. FIG. 4A and FIG. 4B illustrate one particular order and number of the operations of method 400, whereas in other embodiments method 400 may include more of fewer operations in various other orders, and the scope of the claimed subject matter is not limited in these respects. Starting with FIG. 4A, at block 410, IOT device 112 is connected to network 316, power sensor 312, and machine 110. A determination may be made at block 412 whether a specification for machine 110 already exists. If a specification does exist, the specification may be loaded at block 414, and machine 110 may be started up and/or operated according to the specification. If a specification does not exist, at block 416 on power on IOT device 112 may be placed in a listening and learning mode. A tool or machine 110 start process may be run at block 418, and load data may be collected by IOT device 112 at block 420, for example via power sensor 312. The load data may be sent to IOT gateway 314 at block 422, and IOT gateway 314 may send the load data to analytic engine 114 via network 316 at block 424. Once analytic engine 114 receives the load data, analytic engine 114 may determine at block 426 whether the tool or machine 110 is a new system. If the tool or machine 110 is not a new system, machine 110 may be placed into an operations mode at block 428, and IOT device 112 may continue to monitor the operation of machine 110 while it is powered on. If the tool or machine 110 is a new system, method 400 may continue as shown in FIG. 4B.

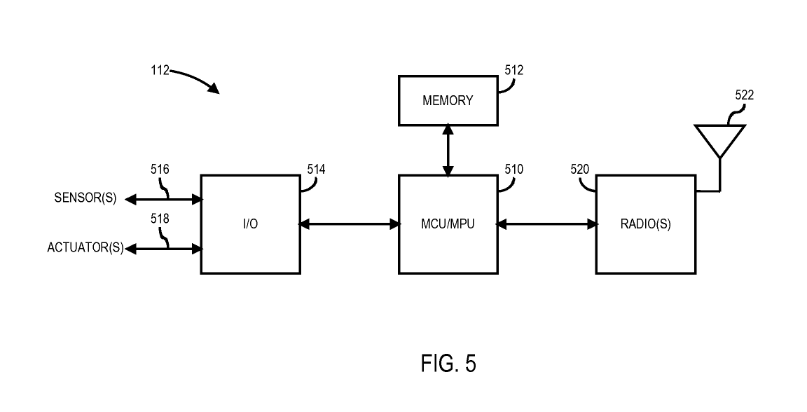

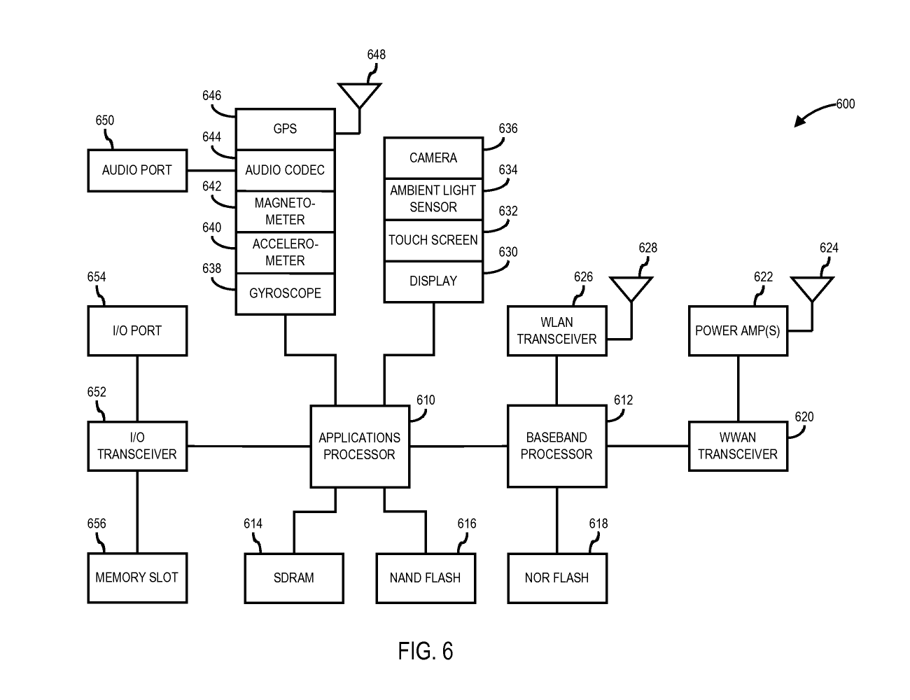

As shown in FIG. 4B, at block 430 a determination may be made whether a signature for the tool or machine 110 is known. If a signature is not known, the tool or machine 110 may be flagged at block 436 for data collection via monitoring by IOT device 112, and analytic engine 114 may obtain a signature for the tool or machine at block 438 via the load data received from IOT device 112. If a signature is known, the signature may be retrieved from a database at block 432, and the starting point for the tool or machine 110 may be refined at block 434 wherein the signature may be updated by analytic engine 114. Method 400 may then proceed from block 434 to block 438 wherein analytic engine 114 may obtain a signature for the tool or machine. It should be noted that in some embodiments method 400 of FIG. 4A and FIG. 4B may be implemented as code or instructions stored in an article of manufacture comprising a non-transitory storage medium such as electronic memory wherein the code or instructions are capable of causing a processor, logic, or other circuitry to execute the method, in whole or in part, although the scope of the claimed subject matter is not limited in these respects. An example of such processors and memory devices comprising non-transitory storage media are shown in and described with respect to FIG. 5 and FIG. 6, below.

Referring now to FIG. 5, a diagram of an Internet of Things (IOT) device in accordance with one or more embodiments will be discussed. FIG. 5 shows an example architecture of the blocks for IOT device 112. IOT device 112 may comprise a processor 510 which may comprise, for example, a microcontroller unit (MCU) or a microprocessor unit (MPU). Processor 510 may couple to a memory 512 which may comprise volatile memory and/or non-volatile memory to store instructions to be executed by processor 510 and furthermore to store data to be acted on by processor 510. Processor 510 may couple to an input/output (I/O) system 514 which may comprise one or more sensor ports 516 and/or one or more actuator ports 518. Processor 510 further may couple to one or more radios 520 having one or more antennas 522 for example to provide a wireless connection to other devices and systems. In one or more embodiments, processor 510 may also include a transceiver (not shown) for coupling via a wired network, although the scope of the claimed subject matter is not limited in this respect. The radios 520 may operate in accordance with one or more standards, for example, Wireless Fidelity (Wi-Fi), Low Power Wi-Fi (LP Wi-Fi), Bluetooth, Bluetooth Low Energy (BTLE), General Packet Radio Service (GRPS), Long Term Evolution (LTE), ZigBee, Internet Protocol version 6 (IPv6) over Low Power Wireless Personal Area Network (6LoWPAN), Wireless Highway Addressable Remote Transducer Protocol (WiHART), Radio-Frequency Identification (RFID), and/or Global Positioning System (GPS), and the wired transceiver may operate in accordance with an Ethernet standard, although the scope of the claimed subject matter is not limited in these respects. It should be noted that the components and/or arrangement of the components of FIG. 5 is one example for IOT device 112. A more complex example for IOT device 112 and/or other devices of analytic system 100 of FIG. 1 and/or architecture 300 of FIG. 3 is shown in and described with respect to FIG. 6, below.

Referring now to FIG. 6, a block diagram of an information handling system capable of implementing utility provisioning with IOT analytics in accordance with one or more embodiments will be discussed. Information handling system 600 of FIG. 6 may tangibly embody any one or more of the network elements described herein, above, including for example machine 110, IOT device 112, analytic engine 114, utility provider 116, and/or IOT gateway 314, with greater or fewer components depending on the hardware specifications of the particular device. Although information handling system 600 represents one example of several types of computing platforms, information handling system 600 may include more or fewer elements and/or different arrangements of elements than shown in FIG. 6, and the scope of the claimed subject matter is not limited in these respects.

In one or more embodiments, information handling system 600 may include an application processor 610 and a baseband processor 612. Application processor 610 may be utilized as a general-purpose processor to run applications and the various subsystems for information handling system 600. Application processor 610 may include a single core or alternatively may include multiple processing cores. One or more of the cores may comprise a digital signal processor or digital signal processing (DSP) core. Furthermore, application processor 610 may include a graphics processor or coprocessor disposed on the same chip, or alternatively a graphics processor coupled to application processor 610 may comprise a separate, discrete graphics chip. Application processor 610 may include on board memory such as cache memory, and further may be coupled to external memory devices such as synchronous dynamic random access memory (SDRAM) 614 for storing and/or executing applications during operation, and NAND flash 616 for storing applications and/or data even when information handling system 600 is powered off In one or more embodiments, instructions to operate or configure the information handling system 600 and/or any of its components or subsystems to operate in a manner as described herein may be stored on an article of manufacture comprising a non-transitory storage medium. In one or more embodiments, the storage medium may comprise any of the memory devices shown in and described herein, although the scope of the claimed subject matter is not limited in this respect. Baseband processor 612 may control the broadband radio functions for information handling system 600. Baseband processor 612 may store code for controlling such broadband radio functions in a NOR flash 618. Baseband processor 612 controls a wireless wide area network (WWAN) transceiver 620 which is used for modulating and/or demodulating broadband network signals, for example for communicating via a 3GPP LTE or LTE-Advanced network or the like.

In general, WWAN transceiver 620 may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 12), 3GPP Rel. 14 (3rd Generation Partnership Project Release 12), 3GPP LTE Extra, LTE Licensed-Assisted Access (LAA), UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, millimeter wave (mmWave) standards in general for wireless systems operating at 10-90 GHz and above such as WiGig, IEEE 802.11ad, IEEE 802.1 lay, and so on, and/or general telemetry transceivers, and in general any type of RF circuit or RFI sensitive circuit. It should be noted that such standards may evolve over time, and/or new standards may be promulgated, and the scope of the claimed subject matter is not limited in this respect.

The WWAN transceiver 620 couples to one or more power amps 642 respectively coupled to one or more antennas 624 for sending and receiving radio-frequency signals via the WWAN broadband network. The baseband processor 612 also may control a wireless local area network (WLAN) transceiver 626 coupled to one or more suitable antennas 628 and which may be capable of communicating via a Wi-Fi, Bluetooth®, and/or an amplitude modulation (AM) or frequency modulation (FM) radio standard including an IEEE 802.11 a/b/g/n standard or the like. It should be noted that these are merely example implementations for application processor 610 and baseband processor 612, and the scope of the claimed subject matter is not limited in these respects. For example, any one or more of SDRAM 614, NAND flash 616 and/or NOR flash 618 may comprise other types of memory technology such as magnetic memory, chalcogenide memory, phase change memory, or ovonic memory, and the scope of the claimed subject matter is not limited in this respect.

In one or more embodiments, application processor 610 may drive a display 630 for displaying various information or data, and may further receive touch input from a user via a touch screen 632 for example via a finger or a stylus. An ambient light sensor 634 may be utilized to detect an amount of ambient light in which information handling system 600 is operating, for example to control a brightness or contrast value for display 630 as a function of the intensity of ambient light detected by ambient light sensor 634. One or more cameras 636 may be utilized to capture images that are processed by application processor 610 and/or at least temporarily stored in NAND flash 616. Furthermore, application processor may couple to a gyroscope 638, accelerometer 640, magnetometer 642, audio coder/decoder (CODEC) 644, and/or global positioning system (GPS) controller 646 coupled to an appropriate GPS antenna 648, for detection of various environmental properties including location, movement, and/or orientation of information handling system 600. Alternatively, controller 646 may comprise a Global Navigation Satellite System (GNSS) controller. Audio CODEC 644 may be coupled to one or more audio ports 650 to provide microphone input and speaker outputs either via internal devices and/or via external devices coupled to information handling system via the audio ports 650, for example via a headphone and microphone jack. In addition, application processor 610 may couple to one or more input/output (I/O) transceivers 652 to couple to one or more I/O ports 654 such as a universal serial bus (USB) port, a high-definition multimedia interface (HDMI) port, a serial port, and so on. Furthermore, one or more of the I/O transceivers 652 may couple to one or more memory slots 656 for optional removable memory such as secure digital (SD) card or a subscriber identity module (SIM) card, although the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining utility provisioning with IOT analytics and many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. An analytic system to control operation of a machine, comprising:
a sensor device to monitor power utilized by the machine, wherein the sensor device collects load data for the machine during startup; and
an analytic engine to determine a start time for the machine based at least in part on the load data for the machine received from the sensor device, and to communicate the start time to the machine.

2. The analytic system as claimed in claim 1, wherein the sensor device comprises an Internet of Things (IOT) device.

3. The analytic system as claimed in claim 1, wherein the sensor device is coupled to a power sensor coupled to a power line of the machine, and the sensor device is configured to receive load data for the machine monitored by the power sensor.

4. The analytic system as claimed in claim 1, wherein the analytic engine is configured to generate a profile for the machine based on the load data during startup, and to utilize the profile to determine the start time for the machine.

5. The analytic system as claimed in claim 1, wherein the sensor device is configured to send the load data for the machine to the analytic engine via an Internet of Things (IOT) gateway.

6. The analytic system as claimed in claim 1, wherein sensor device is configured to send a request to start the machine to the analytic engine, and to receive an acknowledgement from the analytic engine when to start the device.

7. A sensor device to control operation of a machine, comprising:
a processor and a memory coupled to the processor, wherein instructions in the memory configure the processor to:
monitor power utilized by the machine;
collect load data for the machine during startup;
sent the load data for the machine during startup to an analytic engine; and
receive an indication from the analytic engine when to start the machine.

8. The sensor device as claimed in claim 7, wherein the sensor device comprises an Internet of Things (IOT) device.

9. The sensor device as claimed in claim 7, wherein the processor is further configured to:
couple to a power sensor coupled to a power line of the machine; and
receive load data for the machine monitored by the power sensor.

10. The sensor device as claimed in claim 7, wherein the processor is further configured to send the load data for the machine to the analytic engine via an Internet of Things (IOT) gateway.

11. The sensor device as claimed in claim 7, wherein the processor is further configured to:
send a request to start the machine to the analytic engine;
receive an acknowledgement from the analytic engine when to start the device; and
start the machine at a time indicated in the acknowledgement received from the analytic engine.

12. An analytic engine to control operation of a machine, comprising:
a processor and a memory coupled to the processor, wherein instructions in the memory configure the processor to:
receive a request to start the machine;
analyze load data for the machine to determine a start time for the machine; and
send an acknowledgement indicating to start the machine at the determined start time.

13. The analytic engine as claimed in claim 12, wherein the processor is further configured to:
determine if a specification for the machine exists; and
if the specification exists, determine the start time for the machine based at least in part on the existing specification.

14. The analytic engine as claimed in claim 12, wherein the processor is further configured to:
determine if a specification for the machine exists; and
if the specification does not exist, receive load data for the machine during operation, and create a signature for the machine based at least in part on the received load data.

15. The analytic engine as claimed in claim 12, wherein the processor is further configured to:
determine if a signature for the machine is known, and if the signature for the machine is known, control startup of the machine based at least in part on the signature, and refine the signature based at least in part on load data received for the machine.

16. A method to control startup of one or more machines, comprising:
receiving a request to start the one or more machines;
analyzing startup signatures for the one or more machines;
determining a start time for the one or more machines based at least in part on the startup signatures; and
sending an acknowledgement in reply to the request indicating a start time for the one or more machines.

17. The method as claimed in claim 16, wherein said determining comprises delaying a start time of a first machine with respect to a start time of a second machine to start the first machine after a startup process of the second machine is completed.

18. The method as claimed in claim 16, further comprising receiving load data for the one or more machines, and refining the startup signatures based at least in part on the received load data.

19. The method as claimed in claim 16, wherein said determining comprises selecting start times for the one or more machines wherein a maximum allowable current is not exceeded during the startup of the one or more machines based at least in part on the startup signatures.

20. The method as claimed in claim 16, further comprising:
sending a request to a sensor device to monitor load data for the one or more machines;
receiving the load data from the sensor device; and
creating or updating the startup signatures based at least in part on the received load data.

21. An article of manufacture comprising a non-transitory medium having instructions stored thereon to control startup of one or more machines that, if executed by a processor, result in:
receiving a request to start the one or more machines;
analyzing startup signatures for the one or more machines;
determining a start time for the one or more machines based at least in part on the startup signatures; and
sending an acknowledgement in reply to the request indicating a start time for the one or more machines.

22. The article of manufacture as claimed in claim 21, wherein said determining comprises delaying a start time of a first machine with respect to a start time of a second machine to start the first machine after a startup process of the second machine is completed.

23. The article of manufacture as claimed in claim 21, wherein the instructions, if executed, further result in receiving load data for the one or more machines, and refining the startup signatures based at least in part on the received load data.

24. The article of manufacture as claimed in claim 21, wherein said determining comprises selecting start times for the one or more machines wherein a maximum allowable current is not exceeded during the startup of the one or more machines based at least in part on the startup signatures.

25. The article of manufacture as claimed in claim 21, wherein the instructions, if executed, further result in:
sending a request to a sensor device to monitor load data for the one or more machines;
receiving the load data from the sensor device; and
creating or updating the startup signatures based at least in part on the received load data.
